(19) United States
(12) Patent Application Publication
(10) Pub. No.: US 2018/0104144 A1
(43) Pub. Date: Apr. 19, 2018

(54) TRIGGER POINT MASSAGE DEVICE AND SYSTEM

(71) Applicant: POLAR FUSION LLC, Kent, WA (US)

(72) Inventor: Spring S. FAUSSETT, Kent, WA (US)

(21) Appl. No.: 15/786,932

(22) Filed: Oct. 18, 2017

Related U.S. Application Data
(60) Provisional application No. 62/410,257, filed on Oct. 19, 2016.

(51) Int. Cl. A61H 39/04; A61H 39/06

(52) U.S. Cl. CPC A61H 39/04; A61H 2023/002; A61H 39/06

(57) ABSTRACT

A massage device sized and shaped to be individually applied to the user's skin or clothing in order to apply pressure to selected trigger points on the body, the device having a base formed of a first compliant material, and a dome-shaped body extending from the base and formed of a second compliant material that is harder and less compliant than the first compliant material. In addition, a flexible filament having a substantially planar surface can be used to support one or more massage devices and apply the massage devices to selected trigger points on the body.

### BACKGROUND

### Technical Field

The present disclosure is directed to active and passive massaging of trigger points or areas of muscle fiber soreness and, more particularly, to a passive massage device and corresponding system that provides selective hands free massaging of one or multiple trigger points.

### Description of the Related Art

Numerous massage tools are available in the market place that address a variety of needs in manipulation of trigger points associated with the muscles, tendons, and ligaments. Included among these tools are large foam rollers on which the user rests their body and rolls across a supporting surface. These rollers can require a substantial amount of floor space and their size makes it difficult to direct the pressure into hard-to-reach areas. Other rollers include those having a rolling-pin configuration that are bulky, difficult to transport, and require active manipulation of the tool by the user.

### BRIEF SUMMARY

The present disclosure is directed to a soft tissue massage device and system that enables hands-free, passive massaging of trigger points associated with the soft tissue of the muscles, tendons, and ligaments. In addition, the device is small, lightweight, and readily transportable. It combines an appealing appearance with the ability to utilize multiple accessories or other massage devices to enhance the massage experience.

In one implementation of the present disclosure a thumb-sized massage device is provided that is sized and shaped to be individually applied to the user's skin or clothing in order to apply pressure to selected trigger points or other locations on the body. These devices can range in size from the size of the pad of a pinky finger (the shortest finger on the human hand) to the size of a tennis ball, for example. The device has a base formed of a first compliant material and a dome-shaped body extending from the base and formed of the first compliant material.

In accordance with another aspect of the present disclosure, a flexible filament having a substantially planar surface can be used to support one or more massage devices and apply the massage devices to selected trigger points on the body.

In accordance with a further aspect of the present disclosure, a massage device is provided, the massage device including a base having a top surface and an opposing bottom surface, the base formed of a first compliant material; and a body in the form of a dome extending from the top surface of the base, the dome having a generally hemispherical cross-sectional shape and formed of the first compliant material, the dome having at least one sidewall that extends from the base and further having a crown joined to the at least one sidewall.

In accordance with still yet another aspect of the present disclosure, a massage system is provided, the system including a massage device that includes a base having a top surface and an opposing bottom surface, the base formed of a first compliant material; a body in the form of a dome extending from the top surface of the base, the dome having a generally hemispherical cross-sectional shape and formed of the first compliant material, the dome having at least one sidewall that extends from the base and a crown joined to the at least one sidewall. The system also includes a flexible filament having a substantially planar surface extending between first and second terminal ends, the substantially planar surface sized and shaped to receive and retain the base of the massage device in engagement with the filament.

### BRIEF DESCRIPTION OF THE SEVERAL VIEWS OF THE DRAWINGS

The foregoing and other features and advantages of the present disclosure will be more readily appreciated as the same become better understood from the following detailed description when taken in conjunction with the accompanying drawings, wherein:

FIGS. 1-4 are axonometric, top, side, and plan views of a massage device according to one implementation of the present disclosure;

FIG. 5 is a top plan view of a massage device in accordance with an alternative implementation of the present disclosure;

FIGS. 6A-6C are top plan and side views of a massage device in accordance with another alternative implementation of the present disclosure;

FIG. 7 is a top plan view of a massage device in accordance with a further alternative implementation of the present disclosure;

FIG. 8 is a side elevational view of the massage device of FIG. 7;

FIG. 9 is a pictorial view of a hands-free massage system formed in accordance with the present disclosure;

FIG. 10 is a pictorial view of an alternative implementation of a hands-free massage system formed in accordance with the present disclosure;

FIG. 11 is a pictorial view of a further alternative implementation of a hands-free massage system formed in accordance with the present disclosure; and

FIGS. 12A and 12B are cross-sectional views through line 12-12 of FIG. 3 illustrating alternative embodiments of the present disclosure.

### DETAILED DESCRIPTION

In the following description, certain specific details are set forth in order to provide a thorough understanding of various implementations of the disclosure. However, one skilled in the art will understand that the disclosure can be practiced without these specific details. In other instances, well-known adhesives and well-known structures and processes associated with manufacturing techniques have not been described in detail to avoid unnecessarily obscuring the descriptions of the implementations of the present disclosure.

Unless the context requires otherwise, throughout the specification and claims that follow, the word “comprise” and variations thereof, such as “comprises” and “comprising,” are to be construed in an open, inclusive sense, that is, as “including, but not limited to.”

Reference throughout this specification to “one implementation” or “an implementation” means that a particular feature, structure or characteristic described in connection with the implementation is included in at least one implementation. Thus, the appearances of the phrases “in one implementation” or “in an implementation” in various places throughout this specification are not necessarily all referring to the same implementation. Furthermore, the particular features, structures, or characteristics can be combined in any suitable manner in one or more implementations.

As used in this specification and the appended claims, the singular forms “a,” “an,” and “the” include plural referents unless the context clearly dictates otherwise. It should also be noted that the term “or” is generally employed in its sense including “and/or” unless the context clearly dictates otherwise.

As used in the specification and appended claims, the use of “correspond,” “corresponds,” and “corresponding” is intended to describe a ratio of or a similarity between referenced objects. The use of “correspond” or one of its forms should not be construed to mean the exact shape or size.

In the drawings, identical reference numbers identify similar elements or acts. The size and relative positions of elements in the drawings are not necessarily drawn to scale.

The present disclosure is directed in part to a massage device that is configured to be used passively or actively to massage or otherwise provide user-controlled pressure or body weight pressure to the user's trigger points, muscles, ligaments, and tendons as well as other areas of the body. A trigger point (or sometimes referred to as “triggerpoint”) is generally an area of the body where pain or discomfort is felt due to knots in the muscles, stress of the soft tissue that covers the muscles, i.e., the myofascia, and adhesions in the myofascia that interfere with pain-free use of the muscle. Fluids in the muscle and between layers of the tissues are also factors to consider, which can be addressed by these devices. These devices can manipulate with and help lubricate the muscle tissues to get these fluids moving.

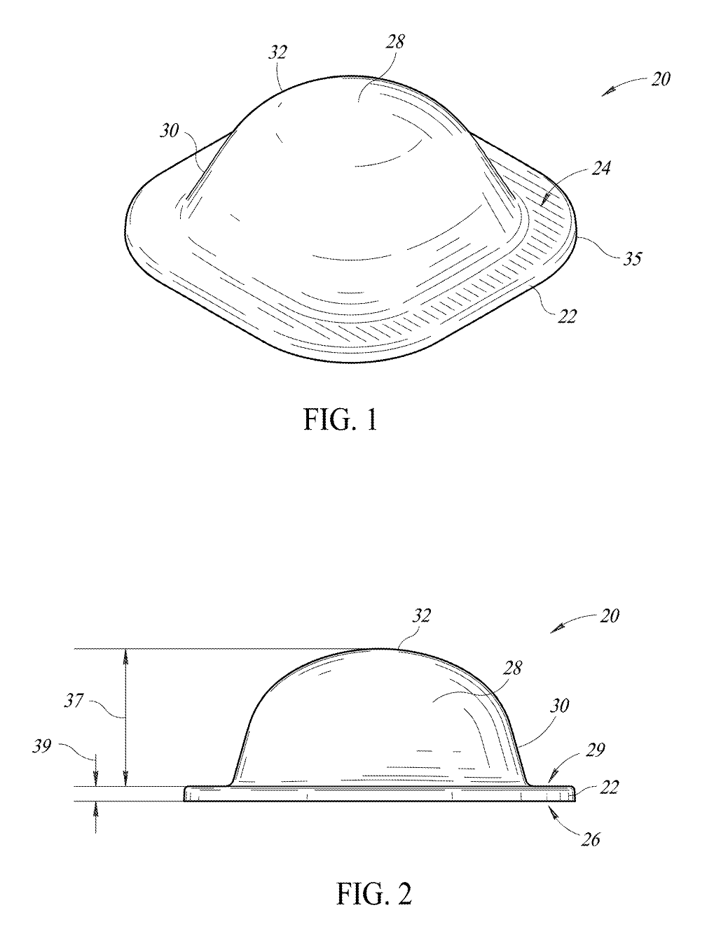

The passive massage device of the present disclosure is preferably applied to a user's skin at a location where the user would like to apply a focused, pin point type massage. One example of the massage device 20 is shown in FIGS. 1-4. This massage device is small, similar to the size of an adult human thumb. The device 20 includes a base 22 and a dome 28. In this example, the base 22 and the dome 28 are one contiguous material, integrally formed, that is compliant, resilient, and exhibits a level of firmness that enables it to not collapse or deform under pressure applied to the human skin tissue and underlying tissues, including subcutaneous tissues, fascia, muscles, tendons, ligaments, and in some case soft and hard bone tissue as sell as cartilage. Ideally the device 20 is solid and does not have any hollowness or indentation in the exterior or bottom surface 26 of the base 22. Ideally, the base 22 is flexible and the dome 28 is firm as described above. The base is flexible to allow for the base to conform to the user's body while not digging into or otherwise irritating the user's skin. This is achieved by forming the base 22 to be thinner than a thickness of the dome 28

In use, the dome 28 is placed on the user's skin such that the bottom surface 26 of the base is facing away from the user's skin and a top surface 24 of the base 22 is facing the user's skin. The device 20 can be used for active massage, where the user applies pressure to the bottom surface 26 and pushes the dome 28 into the user's skin and over a trigger point. The device 20 can also be used for passive massage, such that a piece of tape or other flexible filament can be applied to the bottom surface 26 of the device 20 and to the user's skin to hold the device 20 in place at a desired location on the skin. For example, if the device 20 is applied to a trigger point or a knot in the middle of the user's back, as the user moves, the device 20 will gently massage the knot without application of pressure by the user. However, as the user rests, such as leaning against a back of a chair, gentle pressure from their body weight will compress the device 20 further into the knot, providing additional pressure to the knot. The user may also push on the device 20 for an active massage.

The base 22 is flexible such that it conforms to the contours of the users body when physically attached to the user, such as with tape or a strap. The base 22 also keeps the device 20 or devices in place, such that the base 22 prevents it from flipping or moving. This stabilizes the device 20. These devices 20 are reusable and resilient, such that when the device 20 is removed from the user, the base 22 returns to a substantially flat position, such as that shown in FIG. 2.

As will be appreciated from the foregoing and in summary, the device 20 is a hands-free passive massage tool having the base 22 with the top surface 24 and the opposing bottom surface 26. The device 20 further includes a body in the form of the dome 28 extending from the top surface 24 of the base 22, the dome 28 having a generally hemispherical cross-sectional shape and formed of the first compliant material. Ideally the dome is solid, meaning it does not have a hollow or any hollowness in the interior of the dome 28. The dome 28 has a sidewall 30 that extends from the top surface 24 of the base 22. The dome 28 has a crown 32 or curved top joined to the sidewall 30.

In one implementation of the present disclosure, the dome 28 is a compound dome in which a radius of curvature of the crown 32 as viewed in a cross section elevational view is greater than a radius of curvature of the sidewall 30 as viewed in the cross section elevational view.

In construction, the base 22, dome 28, and crown 32 are formed from a resilient, compliant material, such as rubber or a silicone that can deform and return to its original shape. Preferably the crown 32 has an exterior surface with a static friction value that resists movement of the crown 32 on human skin or on clothing. In the implementation where the dome 28 and the crown 32 are integrally molded with the base 22, the exterior surfaces of these features would all have the same static friction value. And although the device 20 is designed not to move on the human skin or clothing, to resist movement once it has begun, the crown 32 and preferably the entire dome 28 and the base 22 would have a dynamic friction value that resists further movement.

In a preferred implementation, the dome 28 with the crown 32 has a height 37 in the range from and including 7.0 mm to and including 9.0 mm. And in the implementation shown in FIG. 1 wherein the base 22 has a square planform shape, the sides will have a length in the range from and including 20 mm to and including 25 mm. Ideally, the base 22, dome 28, and crown 32 are molded as a single integrated unit to form one solid piece without any hollowness. However, in other implementations the base 22 and the dome 28 with crown 32 can be two or even three separate pieces formed of material with different resiliency and compressibility. Ideally the crown 32 will be solid in order to trap the muscle between multiple crowns as described more fully below.

The base has curved corners 35, which are simply a design choice and other configurations are envisioned, such as shown below in other figures. The base has a height 39 that is in the range from and including 0.1 mm and 1 mm.

An adhesive can be pre-applied on one of the planar bottom surface 26 of the base 22, or if desired to the top surface 24 of the base 22, or it can be applied at the time of use. The adhesive enables temporary affixing of the device 20 to the human skin or to clothing or to a flexible filament described in more detail below. Alternatively, the adhesive can be applied at the time of use. It is to be understood that the adhesive can take many forms, all of which are readily commercially available and will not be described in detail herein. The flexibility of the base 22 and essentially the flexibility of the entire device 20 enables the base 22 with the adhesive to conform to the shape of the user's skin at the point of application.

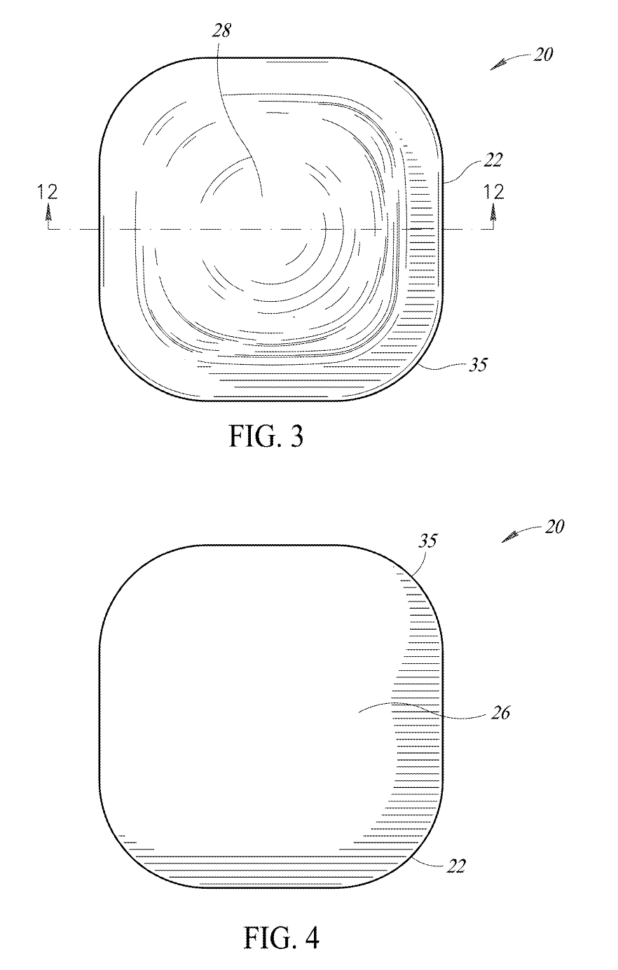

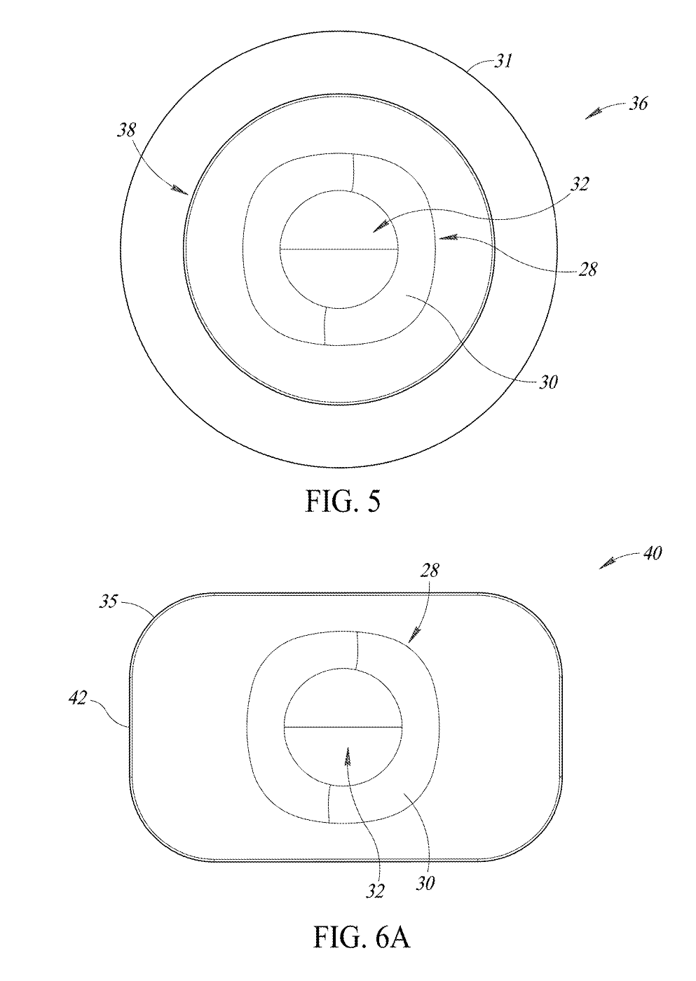

The base 22 can have a planform shape of one from among a triangle, a square, a rectangle, a pentagon, a circle, an oval, a triangle, and a cross with four arms of equal length. Other known geometric shapes as well as non-geometric shapes can be used as well. FIGS. 5 and 6 illustrate a device 36 with a circular base 38 and a device 40 with a rectangular base 42, respectively. It will be further appreciated from FIGS. 1-4 and 6A that the corners 35 are rounded, preferably with a radius of curvature in the range from and including 5 mm to 8 mm and preferably 7 mm. These corners can be right angles or any other suitable design choice because they are not functional and are merely aesthetic in their design.

FIG. 5 includes an optional body adhesive or coupling mechanism 31 that adheres to a back side of the base 38. In use, the crown or dome 32 is placed against a user's skin and the body adhesive 31 attaches to the user's skin to push or otherwise hold the dome 32 against the user's skin. The body adhesive may be included in a kit for purchase along with the device 36. The body adhesive is illustrated as circular, however, other shapes and dimensions are envisioned.

The body adhesive 31 has a surface area that is larger than a surface area of the base 38. A portion of the surface area of the body adhesive that extends past the base 38 adheres or otherwise couples to the user. In an alternative embodiment, a second side of the body adhesive may include a coupling mechanism that allows the user to attach it to an interior of their clothing. For example, the body adhesive may be attached to an interior of tight fitting leggings, which can compress the dome into the user's leg.

FIGS. 6A-6C are top and side views of the device 40, where FIG. 6C shows the device 40 in use with a flexible filament 44 applied to the bottom surface 41 of the device. The device includes the dome 28 that is an integral part of the base 42 and extends away from a top surface 43 of the base. The device 40 may be attached to the flexible filament in a number of ways, such as if the flexible filament is an athletic tape, a first side 51 of the tape is adhesive and a second side of the tape 53 is cloth or smooth. The first side of the tape will couple to the base and will attach the device to the user's skin. The base will conform to the tape, which conforms to the user's skin and body shape where the device is applied. The user can select how tightly to compress the tape and device into the user's muscle. Other examples of applying these massage devices are described below.

The device 40 of FIGS. 6A and 6B may be any one of the devices described in this specification. The device 40 is coupled to the flexible filament 44, such as with an adhesive, by sowing, or any other suitable attachment (permanent or semi-permanent) technique. The flexible filament has a surface area that is larger than a surface area of the base of the device. The surface area may be larger enough to wrap around a user's limb and include coupling mechanisms to attach ends of the flexible filament together. Alternatively, the flexible filament is coupleable to the user's clothing or skin.

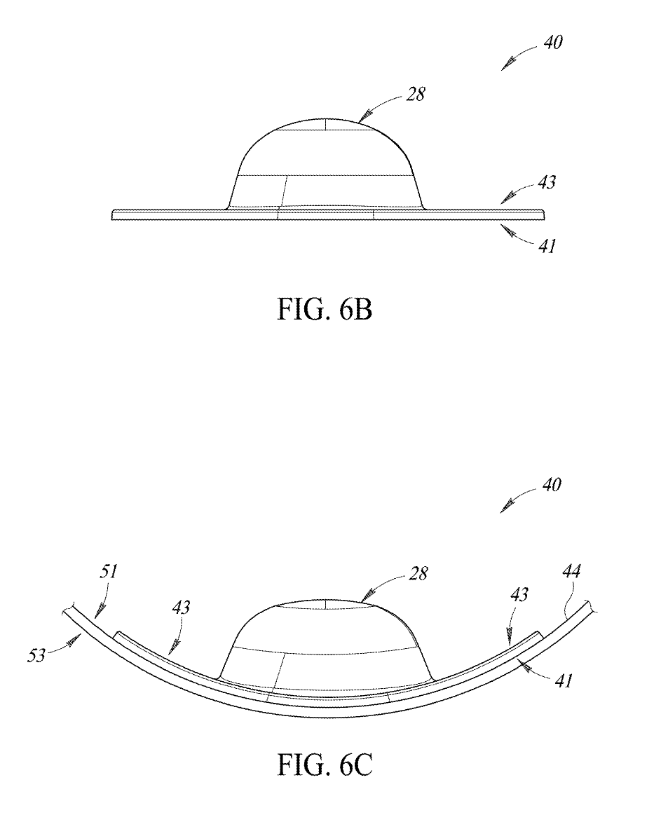

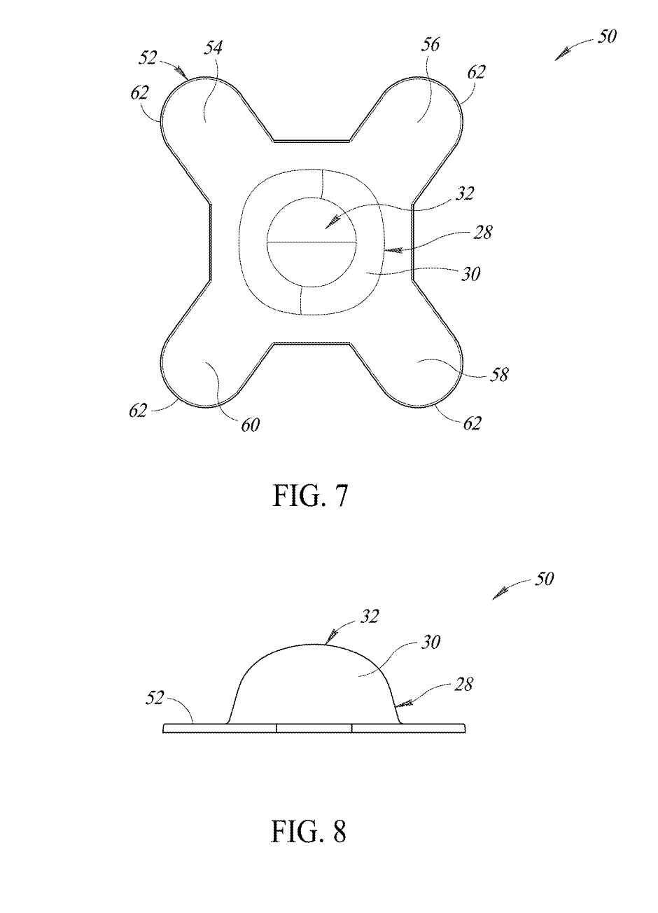

Figures land 8 illustrate yet another implementation of a massage device 50 formed in accordance with the present disclosure. Here, the device 50 has a base 52 with four arms 54, 56, 58, and 60 of equal length and shape extending radially outward. The dome 28, described above with the crown 32 extends from the base 52. Each arm 54, 56, 58, and 60 has a rounded terminal end 62 as seen in the planform view of FIG. 8. A longitudinal axis of each arm 54, 56, 58, and 60 need not be in alignment with an opposing arm nor intersect a center point of the dome 28, meaning the arms may have different axial orientations as seen in FIG. 7.

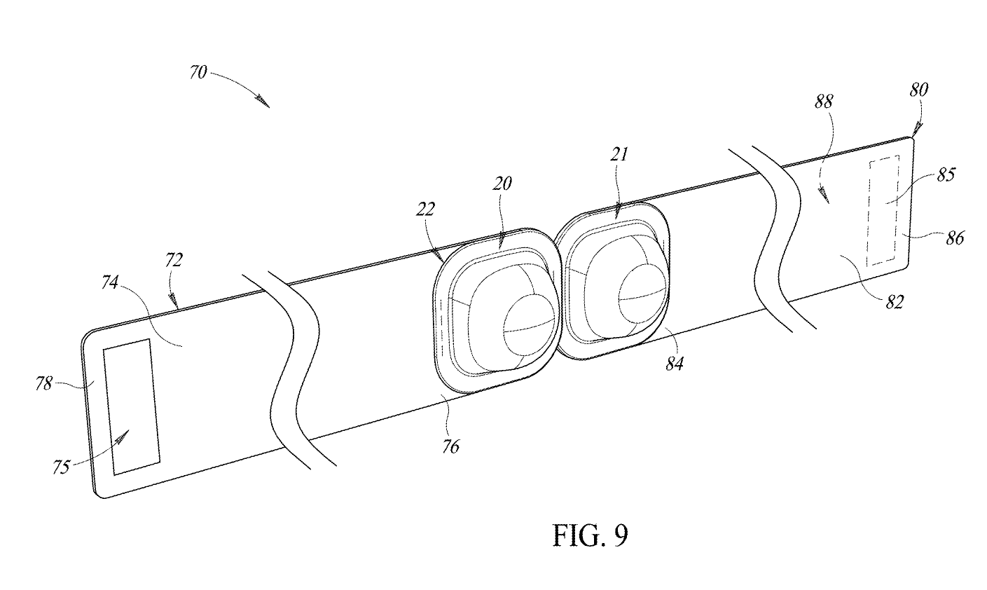

Referring next to FIG. 9, a system 70 is shown for utilizing the massage device 20 described in connection with FIGS. 1-4. The system 70 includes a first flexible filament in the form of a belt or strap 72 having a substantially planar surface 74. A first massage device 20 is mounted on the surface 74 of the strap 72 with adhesive, hook-and-loop fasteners, magnetic fasteners, or other known connection means that permits repositioning or removal of the device 20 from the strap 72. Alternatively, attachment can be permanent such as with stitching or liquid applied bonding. As shown in FIG. 9, the first massage device 20 is positioned adjacent a first end 76 of the strap 72 while a first connection device 75 is located adjacent a second end 78 of the strap 72 on the surface 74.

Also shown in FIG. 9 is a second strap 80 having a second massage device 21 mounted on a planar surface 82 of the strap 80. The second strap 80 is substantially identical in size, shape, and construction to the first strap 72. Likewise, the second massage device 21 is substantially identical to the first massage device 20, and it is positioned at a second end 84 of the strap 80 while a second connection device 85 is located adjacent a first end 86 of the strap 80, but on an opposing planar surface 88 to the planar surface 82.

In a preferred construction the first end 76 of the first strap 72 is connected to the second end 84 of the second strap 80. The connection may be permanent, such as by stitching or other known permanent connection method, or the connection may be detachable, such as with hook-and-loop fasteners or other known devices including, without limitation, one from among a zipper, a button and hole, male and female snap components, turn locks, clips, clasps, frog closures, hook-and-eye fasteners, rivets, toggle closures, magnets, cord stoppers, buckles, and first and second ties.

The system 70 is designed to enable a user to attach the straps 70, 80 around a hand, wrist, arm, foot, angle, leg, or neck and urge the massage devices 20, 21 into contact with the skin to apply pressure to an underlying muscle, trigger point, or one or more trigger points. Alternatively, one or both straps may be positioned on top of a user's skin and held in place with the user's clothing, or attached to the user's clothing, for applying pressure to the skin and underlying trigger points. In accordance with another implementation of the system, more than one massage device 20, 21 may be positioned along the surfaces 74, 82 of the straps 72, 80.

In other variations, instead of two straps 72, 80, the devices 20 are attached to a single piece of material. The devices 20 may be permanently attached or removably attached. If removably attached, the user can chose a number and arrangement of the devices to give them a more specific massage to address their current massage needs. The devices may be attached by adhesive, Velcro, or other known means. Each device can include a magnet that allows the user to easily attach or remove the device from a magnetic portion of the strap. The strap or straps include the connection devices 75, 85, which could be hook-and-loop, buttons, or other attachments, such as a mechanical clip. The straps may be of a flexible material, such as a stretchy textile that will conform to the user's body and allow the user to select an amount of pressure to apply with the textile and the device.

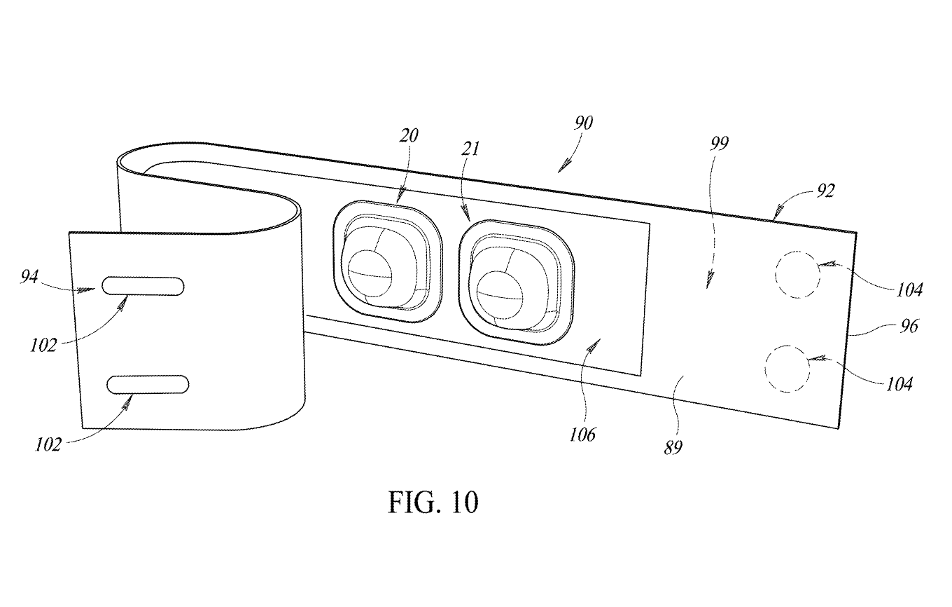

FIG. 10 illustrates an alternative design of a hands free massage system 90 utilizing a flexible belt or strap 92 having first and second ends 94, 96 and a substantially first planar surface 98 with an opposing second planar surface 99. First and second connection members 102, 104 are located at the first and second ends 94, 96, respectively, with the first connection member 102 on the first planar surface 98 and the second connection member 104 located on the second planar surface 99. The connection members may be, without limitation, one from among hook-and-loop fasteners, a zipper, hook-and-loop fasteners, a button and hole, male and female snap components, turn locks, clips, clasps, frog closures, hook-and-eye fasteners, rivets, toggle closures, magnets, cord stoppers, buckles, and first and second ties.

A mounting strip 106 is positioned on the first planar surface 98 of the belt 92 between the first and second ends 94, 96 and attached thereto, preferably with a permanent attachment, such as bonding with adhesive, stitching, or other known means. Positioned on the strip 106 are two massage devices 20, 21, which are held in place via a releasable connector, such as hook-and-loop or a more permanent method, such as stitching. Alternatively, the mounting strip 106 may have magnetic attraction capabilities and the massage devices 20, 21 will have magnets formed in the base thereof that are attracted to the magnetic strip. The positioning of these massage devices 20, 21 as well as the use of more or less massage devices is determined by the user. More massage devices mounted on the strap will apply pressure to a larger area, such as a larger knot or trigger point or multiple trigger points. The massage devices can be grouped together in one region or be spaced to address multiple locations at one time.

The mounting strip 106 may be omitted and the devices may be directly attached to the belt 92. Alternatively, the devices may be directly integrated into the material of the belt or the mounting strip.

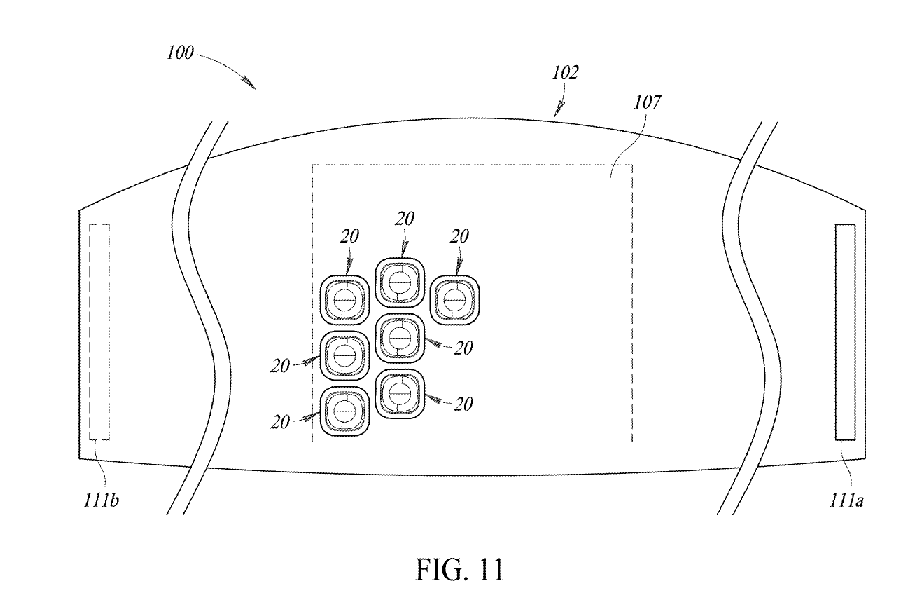

FIG. 11 illustrates an alternative implementation of a massage system 100 in which multiple massage devices 20 are positioned in a grid-like arrangement on a support 102, such as a flexible belt, strap, sleeve, fabric, or piece of clothing. A user can position the massage devices 20 where desired using hook-and-loop fasteners or other temporary mounting methods as discussed herein. This enables a user to apply pressure to one or more selected trigger points. The user may also interact with the system 100 by moving one or more of the massage devices 20 with their hand while keeping the crown on the trigger point.

The support 102 gives the user ultimate flexibility in the number and arrangement of the massage devices to adjust to the current needs of the user. This can be worn on top of or under the user's clothing. This could be integrated as part of the user's clothing, such as a shirt that includes a device mounting area 107. The device mounting area includes a feature that is configured to interact with and couple to a feature on the bottom surface of the massage device such that the user can create an arrangement of the massage devices to fit their particular need. Attachment means 111a and 111b are provided to couple ends of the support 102 together, such as with hook-and-loop, buttons, or other attachment features. These attachment features may be adjustable to adjust an overall size of the support to change a location of the user to which the support is attached, i.e. around the user's leg as compared to around the user's waist.

In another implementation, more than one of the massage devices may be attached together such that there is a group of permanently attached massage devices that can be applied to the user's skin. Each of the massage devices described herein can include a rigid portion and a flexible portion that are formed of the same material, i.e., the base and the dome. In other implementations, the crown may be formed of a different material than the dome and base, such as a semi-solid gel that is supported on the relatively rigid dome. The dome is rigid in comparison to the base. The dome is compressible, such that in use the dome responds to the user's skin and when not in use, returns to the dome's original shape.

The devices described herein are small, such that a width and length of the base are each one inch or less. In other alternative implementations, a top surface of the dome can include a texture that is different from the sidewalls. A group of the devices can be sold together where different ones of the devices include a different texture or surface shape at the top of the dome. For example, one dome top may include an array of small bumps or dots while another will have a smooth curvature, such as the one shown above with respect to FIG. 1.

In an alternative implementation, the devices may be disposable, where the crown of the dome includes reservoir having a burstable cover or the dome may have a burstable sac of a small amount of fluid, such as massage oil or a pain relief ointment. When the crown is compressed in to the user's skin, the crown or sac containing the fluid or liquid may burst or otherwise release oil or pain relief ointment to aid in the massage with the device. The dome beneath the crown can be a size and shape that allows for comfortable massage after the crown or attached sac releases the fluid.

The dome may include a small void or hollow space that allows for a small amount of fluid to be stored that can be slowly released through the crown to a user's skin. For example, during transport and before use, there may be a tab or seal that covers the void to keep the fluid in. Once the tab is removed, the fluid may flow out. In one implementation, the crown may include a filter or cover that allows for slow release of the fluid over a period of time, such as an hour. The release can be triggered by pressure applied to the crown such as when the crown is pressed on the user's skin.

The massage devices and systems described herein can be packaged and sold as individual components or in kits. The kits could include various length straps and belts, and massage devices with a variety of different shaped bases described above.

In use, a user can apply a single massage device with the dome against the skin and move it around with their hand or hold it in place with adhesive or body tape, a belt or strap, or an article of clothing. Multiple massage devices can also be used at a single trigger point location on the body or at multiple trigger points and selectively arranged on a support as desired.

A material used to form any one of the devices described herein may include healing materials. For example, during a manufacturing process healing materials, such as vitamin E, essential oils, magnets, copper components, and other therapeutic materials, can be incorporated in the material. The materials may be plastics or rubbers or other suitable materials.

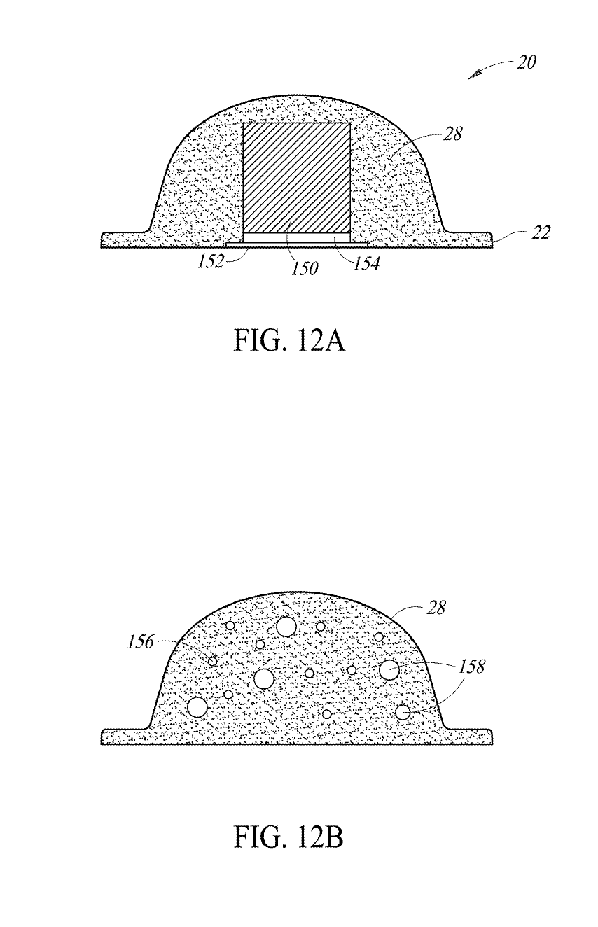

FIGS. 12A and 12B are cross-sectional views through line 12-12 of FIG. 3 illustrating various embodiments of healing materials incorporated within the devices of the present disclosure. In particular, in FIG. 12A a magnet 150 is positioned within the dome 28 of the device 20. The magnet may be cylindrical or any other suitable shape, such as a sphere. A portion of the material covers the magnet to completely surround the magnet with the material of the dome.

In an alternative embodiment, a portion 152 of the base 22 may be removable such that the magnet 150 can be removed and replaced with a different healing component. For example, instead of the magnet 150 a heated component may be inserted. The heated component may slide into an opening 154. The portion 152 may be held in place with one of the flexible filaments described in this disclosure, such as a piece of tape.

FIG. 12B is a cross-sectional view of the dome 28 formed from a material that includes healing components 156 and 158. Two different components are shown, however, there may be a single component or more than two components. The healing components may include heatable components, such as copper or other materials that can retain heat and dissipate heat to the user's muscles. The healing components can include essential oils in conjunction with the heatable components. The components may also include magnetized materials.

The various implementations described above can be combined to provide further implementations. For example, the massage device 20 may be removably attached or permanently attached to an article of clothing that is worn by a user. These and other changes can be made to the implementations in light of the above-detailed description. In general, in the following claims, the terms used should not be construed to limit the claims to the specific implementations disclosed in the specification and the claims, but should be construed to include all possible implementations along with the full scope of equivalents to which such claims are entitled. Accordingly, the claims are not limited by the disclosure.

1. A hands-free passive massage device, comprising:
a base having a top surface and an opposing bottom surface, the base formed of a first compliant material; and
a body in the form of a dome extending from the top surface of the base, the dome having a generally hemispherical cross-sectional shape and formed of the first compliant material, the dome having a sidewall that extends from the base and a crown joined to the sidewall.

2. The device of claim 1 wherein the dome comprises a compound dome in which a radius of curvature of the crown as viewed in a cross section elevational view is greater than a radius of curvature of the sidewall as viewed in the cross section elevational view.

3. The device of claim 1, comprising an adhesive on one of the bottom surface of the base and the top surface of the base.

4. The device of claim 1 wherein the base has a planform shape of one from among a triangle, a square, a rectangle, a pentagon, a circle, an oval, and a cross with four arms of equal length.

5. The device of claim 1 wherein when the crown of the dome has an exterior surface with a static friction value that resists movement of the crown on human skin.

6. The device of claim 1 wherein the dome with the crown has a height in the range from and including 7.0 mm to and including 9.0 mm.

7. The device of claim 1 wherein the base has a square planform shape with sides having a length in the range from and including 20 mm to and including 25 mm.

8. A hands-free passive massage system, comprising:
a massage device that comprises:
a base having a top surface and an opposing bottom surface, the base formed of a first compliant material;
a body in the form of a dome extending from the top surface of the base, the dome having a generally hemispherical cross-sectional shape and formed of a second compliant material that is harder and less compliant than the first compliant material of the base, the dome having at least one sidewall that extends from the base and a crown joined to the at least one sidewall; and
a flexible filament having a substantially planar surface extending between first and second terminal ends, the substantially planar surface sized and shaped to receive the base of the massage device and the massage device structured to be repositionable on the flexible filament.

9. The system of claim 8, comprising an attachment structure that attaches the base of the massage device to the planar surface of the flexible filament.

10. The massage device of claim 8, comprising a coupling apparatus that releasably couples the first and second terminal ends of the flexible filament together.

11. The system of claim 8 wherein the dome comprises a compound dome wherein a radius of curvature of the crown as viewed in a cross section elevational view is greater than a radius of curvature of the at least one sidewall as viewed in the cross section elevational view.

12. The system of claim 8, comprising an adhesive on one of the bottom surface of the base and the top surface of the base.

13. The system of claim 8 wherein the base has a planform shape of one from among a triangle, a square, a rectangle, a pentagon, a circle, an oval, and a cross with four arms of equal length.

14. The system of claim 8 wherein when the crown has an exterior surface with a static friction value that resists movement of the crown on human skin.

15. The system of claim 8 wherein the dome with the crown has a height in the range from and including 7.0 mm to and including 9.0 mm.

16. The system of claim 15 wherein the base has a square planform shape with sides having a length in the range from and including 20 mm to and including 25 mm.

17. The system of claim 8, comprising a plurality of massage devices sized and shaped to be repositionable on the flexible filament.

18. A massage device kit, comprising:
a massage device that comprises:
a base having a top surface and an opposing bottom surface bounded by a circumscribing peripheral wall that joins to the top and bottom surfaces, the base formed of a first compliant material;
a main body in the form of a dome extending from the top surface of the base, the dome having a generally hemispherical cross-sectional shape and formed of a second compliant material that is harder and less compliant than the first compliant material of the base, the body having sidewalls that extend from the base and a crown joined to the sidewalls; and
a flexible filament having a substantially planar surface extending between first and second terminal ends, the substantially planar surface sized and shaped to receive the base of the massage device.
